(19) United States
(12) Patent Application Publication
(10) Pub. No.: US 2006/0286530 A1
(43) Pub. Date: Dec. 21, 2006

(54) System and method for collecting question and answer pairs

(75) Inventors: Brady D. Forrest, Seattle, WA (US); Christopher B. Weare, Bellevue, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/146,606

(22) Filed: Jun. 7, 2005

(51) Int. Cl. G09B 7/00

(52) U.S. Cl. 434/323

(57) ABSTRACT

A database collects questions and answers to the questions, each question having a plurality of answers. A question interface provides the questions to the database from various sources. An answer interface provides the answers to the database from various sources. A rating system assigns an accuracy rating to each of the plurality of answers for each question.

### TECHNICAL FIELD

Embodiments of the present invention relate to the field of communications and sharing of information. In particular, embodiments of this invention relate to a system and method which collects questions from various sources and accumulates answers to the collected questions from various sources and/or via a search engine. In addition, embodiments of this invention relate to a system and method for collecting question and answer pairs which system and method are integrated with messaging systems.

### BACKGROUND OF THE INVENTION

Many people have questions to which they desire accurate answers. For example, some users type questions into their personal websites (aka blogs). Many of these questions get answered either in the comments or on another blog. There is a need for a system for bringing these question-answer pairs together for searchable database.

Some prior systems provide answers to questions. However, these systems lack the capability to collect multiple answers from various sources and rating the answers. There is a need for a system and method for improving question and answer pair collection across multiple personal websites, messaging networks and other modes of communication. There is also a need for a system which rates answers and rates answerers.

Accordingly, a system and for collecting question and answer pairs is desired to address one or more of these and other disadvantages.

### SUMMARY OF THE INVENTION

This invention improves communication of answers to questions. For example, the system and method of the invention improves communication across multiple personal websites. Many people type questions into their personal websites (blogs). Some of these questions get answered either in the comments or on another blog. The system and method of this invention bring these question-answer pairs together in a searchable database by providing a question-answering service where end users can ask others for answers to any questions.

In one embodiment, it is contemplated that the system and method may have an economy, such as points, which may be used by users to value questions, answers and users who provide answers. Users who answer questions correctly receive points, which are awarded by the questioner when they believe the question has been answered correctly. The questioner can also put an answer up for community vote to determine if the answer is perceived as being correct by the community. Users who are perceived as doing a great job helping each other are publicly recognized in that they gain reputation and prestige. The answers funnel back into the system and method to increase the accuracy of answers.

In an embodiment, a system collects question and answer pairs in a database via a question interface and an answer interface. A rating system assigns an accuracy rating to each answer for each question.

In accordance with one aspect of the invention, a method provides for collecting question and answer pairs. Collected answers from various sources are assigned an accuracy rating.

Alternatively, the invention may comprise various other methods and apparatuses.

Other features will be in part apparent and in part pointed out hereinafter.

### BRIEF DESCRIPTION OF THE DRAWINGS

FIG. 1 is an exemplary embodiment of a database according to the system and method of the invention.

FIG. 1A is an exemplary embodiment of the question interface of FIG. 1 according to the system and method of the invention.

FIG. 1B is an exemplary embodiment of the answer interface of FIG. 1 according to the system and method of the invention.

FIG. 1C is an exemplary embodiment of the syndication interface of FIG. 1 according to the system and method of the invention.

FIG. 2 is an exemplary block diagram illustrating an architecture according to one embodiment of the invention.

FIG. 3 is an exemplary screen shot of a home page according to one embodiment of the invention.

FIG. 4 is an exemplary screen shot of a profile page according to one embodiment of the invention.

FIG. 5 is an exemplary screen shot of a profile edit page according to one embodiment of the invention.

FIG. 6 is an exemplary screen shot of a view question page according to one embodiment of the invention.

FIG. 7 is an exemplary screen shot of an offer bid page according to one embodiment of the invention.

FIG. 8 is an exemplary screen shot of a community add question page according to one embodiment of the invention.

FIG. 9 is an exemplary screen shot of a community results page according to one embodiment of the invention.

FIG. 10 is an exemplary screen shot of a module page according to one embodiment of the invention.

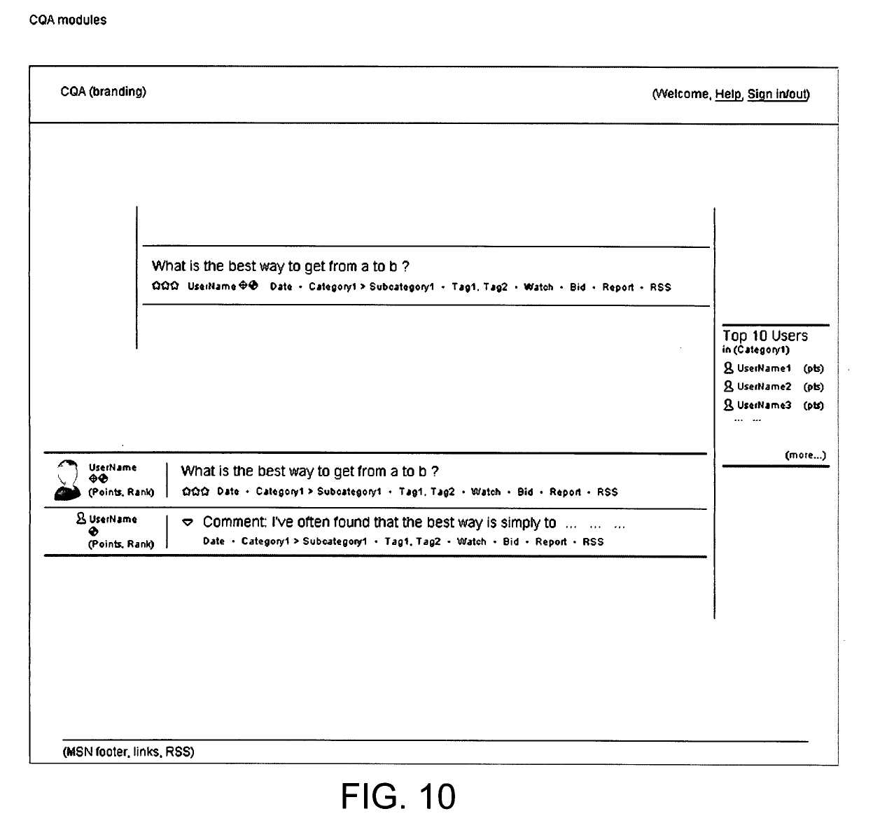

The screenshot shows a question that is being asked by a user: “What is the best way to get from a to b?” Below the question is the category and tag information for the question. Below the question is the richer description of the question, which contains the information of the individual who asked the question along with one of the answers.

FIG. 11 is a block diagram illustrating one example of a suitable computing system environment in which the invention may be implemented.

Corresponding reference characters indicate corresponding parts throughout the drawings.

### DETAILED DESCRIPTION OF THE INVENTION

A free, community-based question-answering service and system is disclosed. In one embodiment, end users can ask other end users—some of whom are self-professed experts—for answers to all kinds of questions. These questions might range from purely factual (what is the population density of Hong Kong) to trivia (who starred in the Titanic?) to practical (what is the best way to stop rain gutters from plugging up).

In one embodiment, an economy is established to rate questions, answers and end users providing answers (herein “answerers”). For example, when questioners join the system, they are given a fixed number of points (artificial currency) with which they can pay for answers to questions that have not yet been answered. Answerers who answer questions correctly receive points, which are awarded by the questioner when the questioner believes the answer is correct. The questioner can also put an answer up for community vote to determine if it's correct. Answerers who provide accurate answers or otherwise help others are publicly recognized so that they gain reputation and prestige. The answers funnel back into the system to make it smarter with each answer.

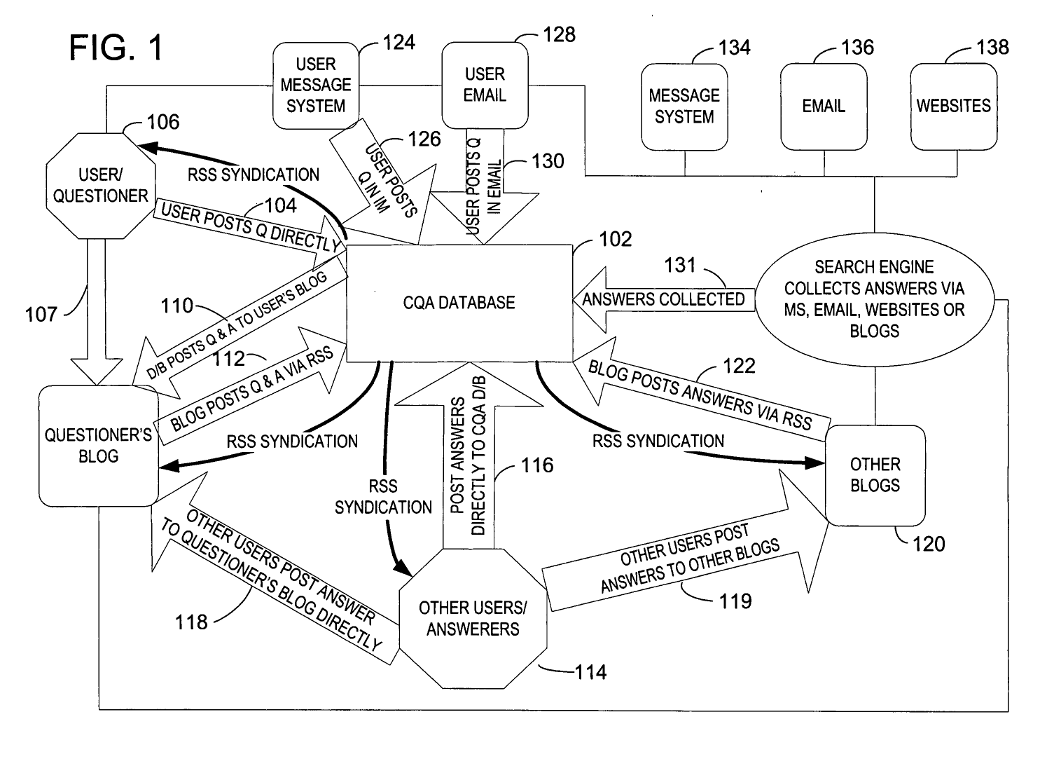

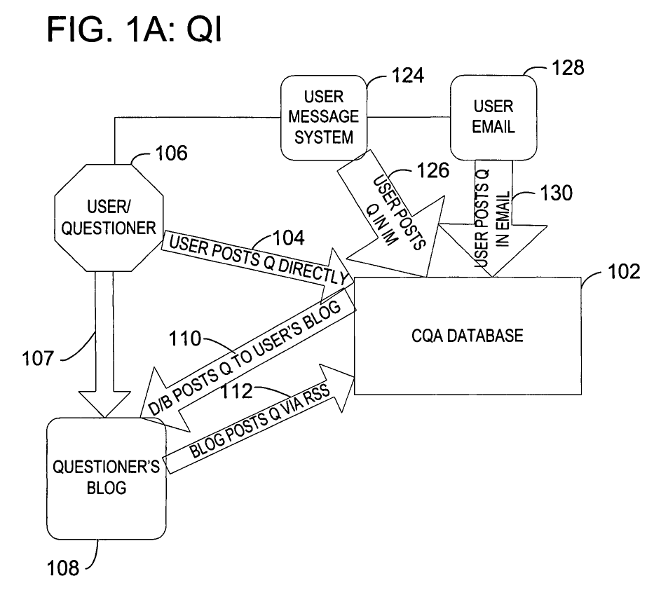

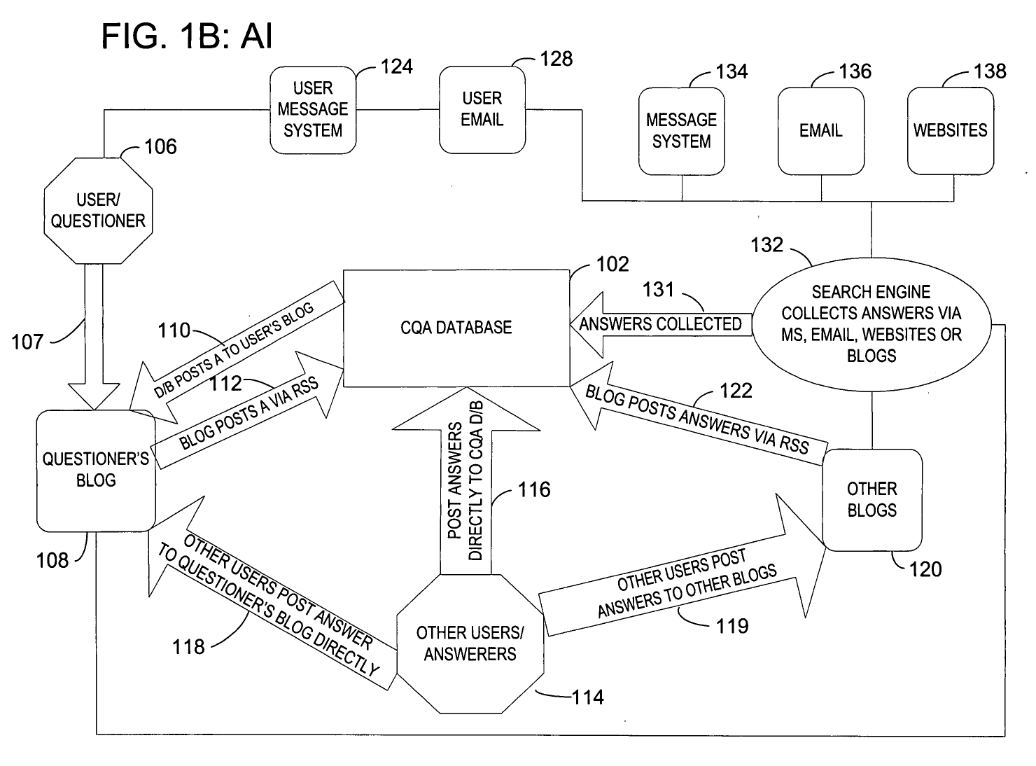

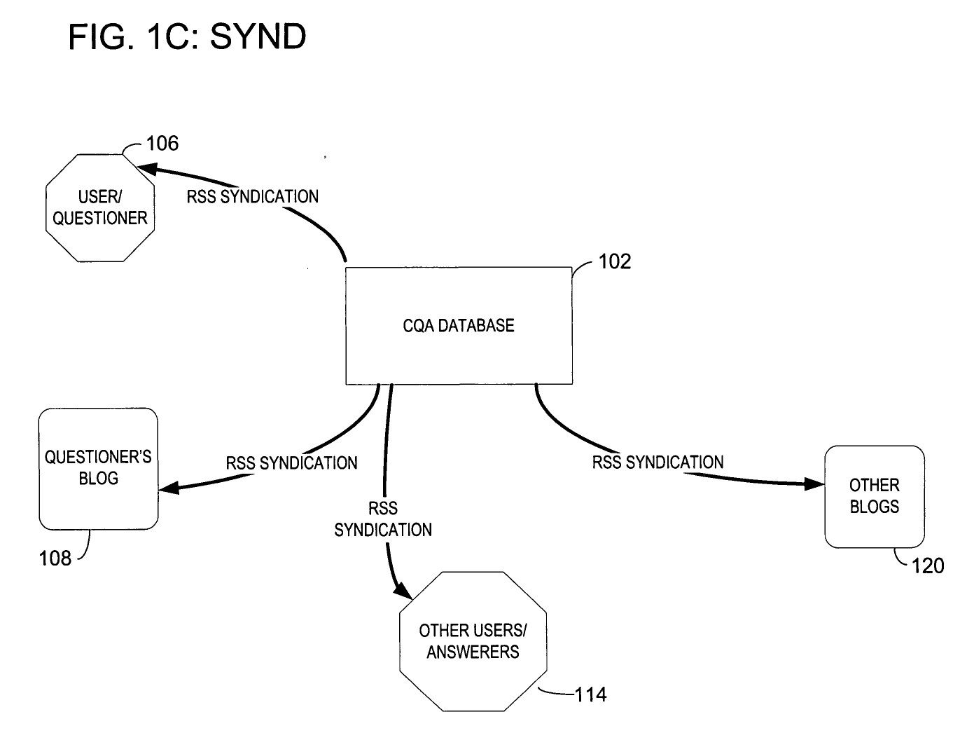

Referring to FIG. 1, one embodiment of a system for collecting question and answer pairs according to the invention is illustrated. A database 102 for collecting question and answer pairs (CQA) interfaces with various sources and resources to receive questions and to receive answers to the questions as well as to provide answers. In general, the CQA database 102 has a question interface which receives questions from various sources and resources. In addition, database 102 has an answer interface for providing answers to the questions it receives, which answers are provided to various sources and resources. In one embodiment, a rating system assigns an accuracy rating to each of the plurality of answers for each question within the database 102.

Question Interface

In one embodiment, the question interface as shown in FIGS. 1 and 1A would include a questioner interface 104 which allows a user or a questioner 106 via a computer or other communication device to post questions to the database 102 directly. If the questioner 106 has a blog 108, in one embodiment the system may directly post the question from the database 102 through the questioner's blog 108 as indicated by 110 such as by an RSS interface. Alternatively, the questioner 106 may post a question on their blog 108 via 107 and a blog interface 112 such as an RSS interface would post the question to the database 102. Thus, the system will facilitate user's posting questions/answers to their designated blogs automatically via the blog's application program interface (API). It is also contemplated that the CQA database 102 may receive questions from other sources or resources such as communications systems. In one embodiment, the user 106 may configure their messaging system 124 to post questions to the database 102 via the messaging system's API or other interface 126. Similarly, the user 106 may configure their email system 128 to post questions within emails to the database 102 via an email system API or other interface 130.

Answer Interface

Once a question has been posted to a blog 108, comments on blog 108 may be posted to database 102 as potential answers to that question by blog interface 112. As an example, a user 106 posts to the database 102 via interface 104 a question asking about “how to raise a puppy?” The question is automatically posted to the user's blog 108 via interface 110. Other users or answerers 114 may answer the question by posting answers directly to the database 102 via an interface 116. Readers of the questioner's blog 108 may also answer the question in the blog's comments by posting answers to the questioner's blog 108 as indicated by arrow 118. Alternatively, answerers 114 may be presented with a link 110 between the database 102 and blog 102 which allows them to post answers to the questioner's blog 108 via database 102. All the comments in the questioner's blog 108 which appear after the question are pulled into the CQA database 102 and are treated as answers to the question. As noted below, the comments become searchable and are available to be rated as the “best answers” to the question. When an answerer posts answers directly to the CQA database 102, the answerer may also configure the interface 116 to post the answers to the answerer's blog 120 via RSS syndication.

The system may be configured to track knowledge across blogs other than the questioner's blog 108. For example, answerers 114 may post answers to their blog or other blogs 120 via 119. These other blogs 120 may be configured to post answers to the CQA database 102 via their API using an RSS or other interface 122. It is contemplated that the user interface with the CQA database 102 would allow users 106 to designate other users 114 that they wish to keep track of. This enables the user to use the database 102 as a way of keeping track of discussions across multiple blogs 120.

It is also contemplated that the CQA database 102 may collect answers from various sources or resources such as communication systems. In one embodiment, a search engine 132 collects answers via messaging systems (MS) 134, email systems 136 or websites 138 or other blogs 120 and provides the answers to database 102 via 131. In addition, the search engine 132 may collect answers from the user's email system 128 and the user's messaging system 124.

Syndication Interface

As shown in FIGS. 1 and 1C, it is further contemplated that the CQA database may include a syndication system for syndicating questions and/or answers. For example, in one embodiment, the database 102 would use an RSS syndication interface to syndicate answers to the user questioner 106, to the questioner's blog 108, to other users/answers 114 or to other blogs 120. Syndication may also be based on various criteria. For example, in one embodiment, category syndication may be implemented. In particular, each category (be it dynamic or static) will be published as an XML feed. This will allow for users to stay notified of new questions and answers in a given category. As another example, user syndication may be employed in one embodiment. Users can add questions to their own XML feed. This will allow the user to stay informed with respect to questions and users they care about.

Economy

In one embodiment, it is contemplated that the system would include an economy or other rating system for assigning an accuracy rating to each of the plurality of answers for each question which are stored in the CQA database 102. In particular, a point system may be employed to encourage or discourage behavior by answerers and to rate various answerers. As a particular example, consider an economy where more points equal a higher rank. Preferably, the point system would be simple. Although simple point systems may be subject to some gaming by certain users, complicating the system discourages other users and has a concurrent disadvantage. Points may be awarded by the CQA system itself or by the questioner 106.

Table 1 illustrates actions in one embodiment which may be used for rewarding/decrementing points.

TABLE 1

| | | Origin of |
|---|---|---|
| Action | Point | Points |
| Answer Question * | 1 | CQASystem |
| Get Best Answer | 25 | CQASystem |
| Get Best Answer | QuestionBet | CQAAsker |
| Participate in CommunityVote | 1 | CQASystem |
| Correctly choose CommunityVote | 5 | CQASystem |
| AbandonQuestion | −10 | CQAAsker |
| Log Into System | 1/day | CQASystem |

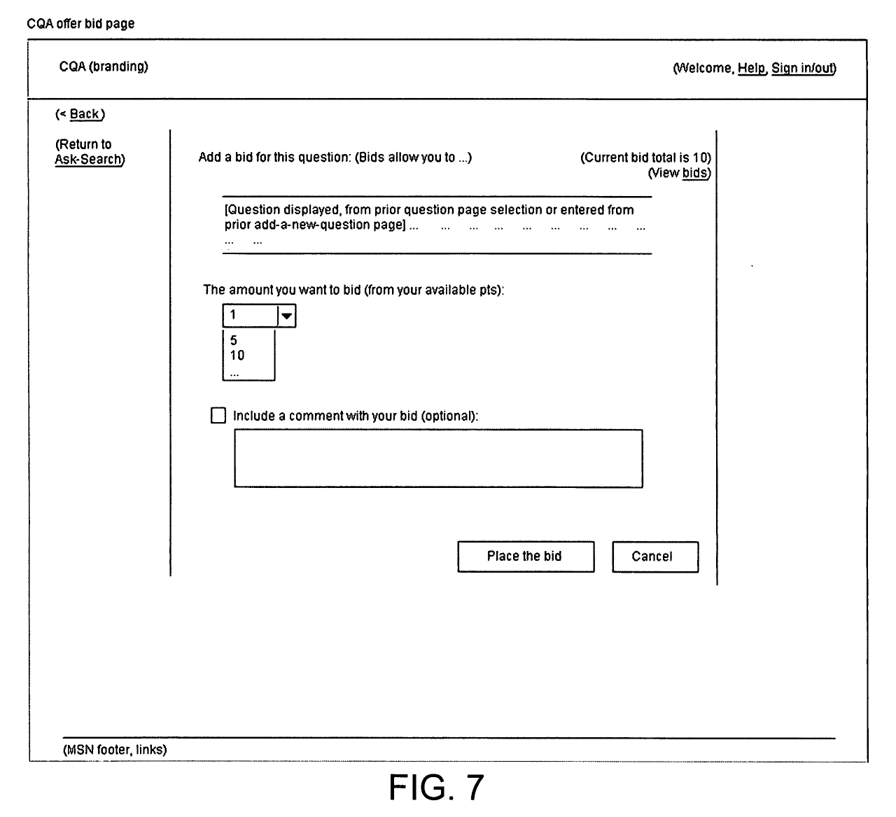

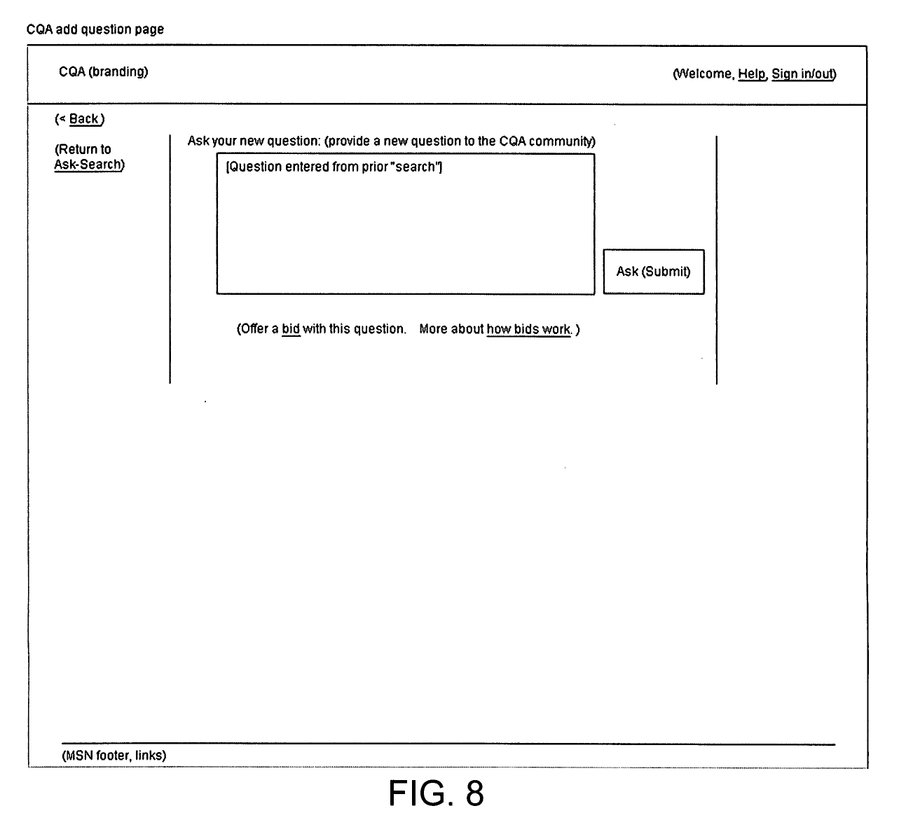

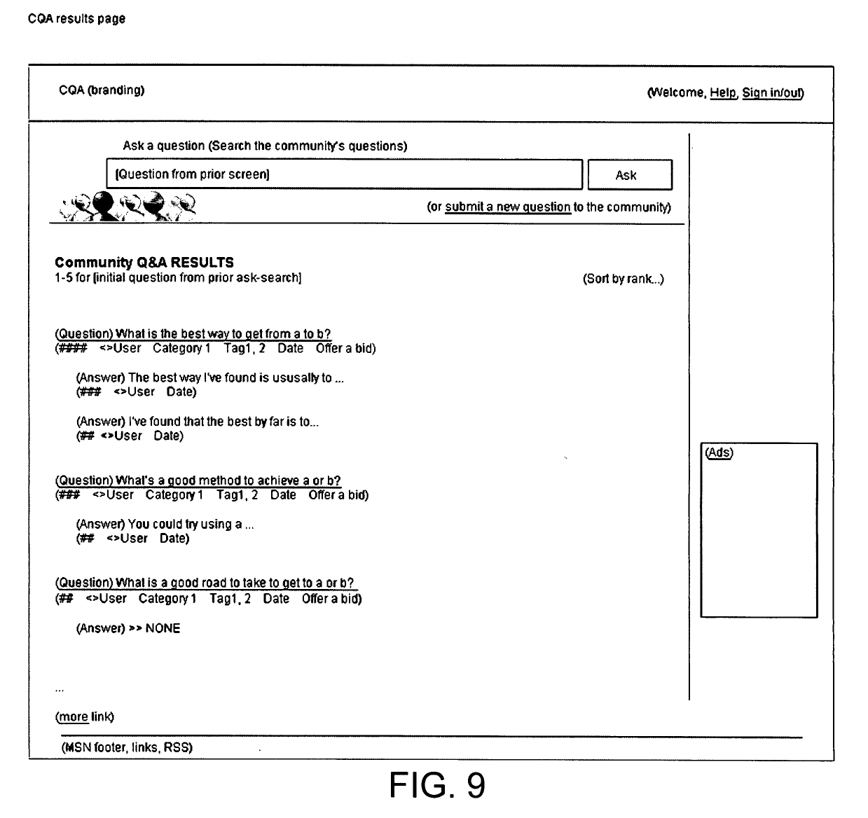

According to Table 1, in this embodiment, an answerer would get one point from the CQA system for answering a question. If the CQA system concludes that the answerer had the best answer, the answerer would be granted 25 points from the CQA system. Alternatively or in addition, the questioner 106 may place a “bet” paying the answerer that answers the question the best the amount of the bet (see FIG. 7). The amount of the bet would be deducted from the questioner's account and provided to the answerer's account if the questioner concludes that the answerer has the best answer. Alternatively, a question may be put up for a community vote and any answerer voting on the answer of others would be granted a point by the CQA system (see FIGS. 8 and 9). In addition, answerers who are chosen by the community vote as providing correct answers would be awarded 5 points by the CQA system. If a questioner decides to abandon a question the questioner would lose 10 points. Finally, to encourage use by both questioners and answerers, the CQA system would award a point per day for a user that logs onto the system.

Appendix 1 provides a discussion as to how users may be able to game such a system and various ways that such gaming can be inhibited. Those skilled in the art will recognize that various types of economies are subject to various types of gaming. As noted above, there is a need to strike a balance between the complexity of the economy which discourages use and the simplicity of the economy which encourages use and may be subject to some gaming.

Users would gain or lose rewards or points or other currency of the economy in place depending on the ranking that they receive over time. Possible types of rewards may include a medallion associated with their profile which is displayed with their questions or displayed with their answers or displayed on their profile page. In addition, the CQA may have user rankings and the points may be converted for use on other systems.

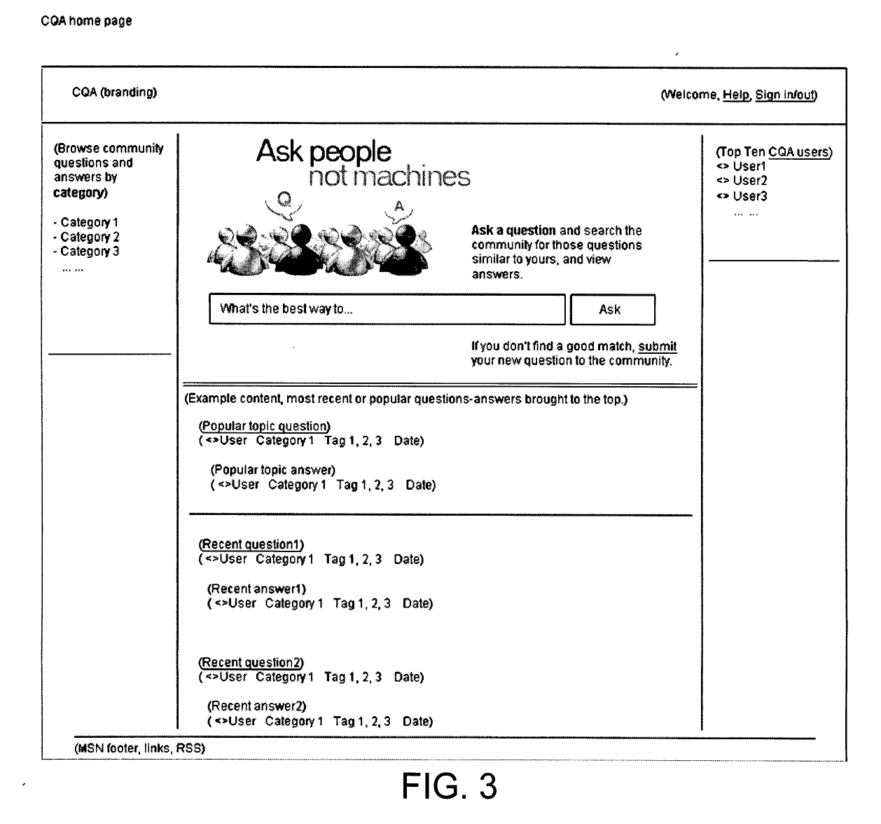

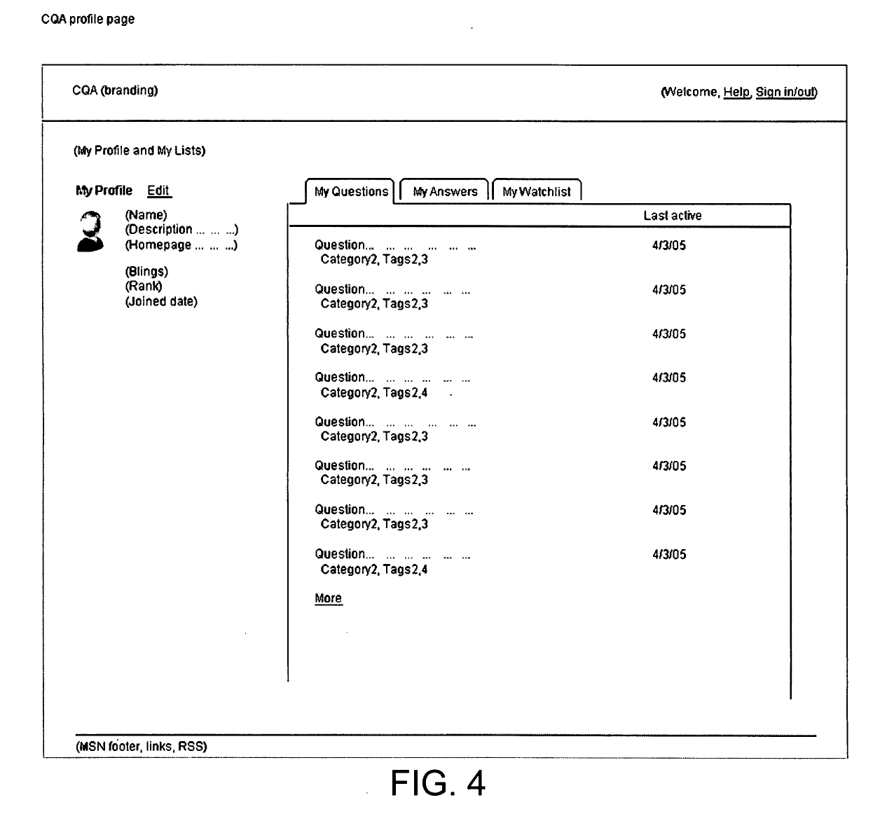

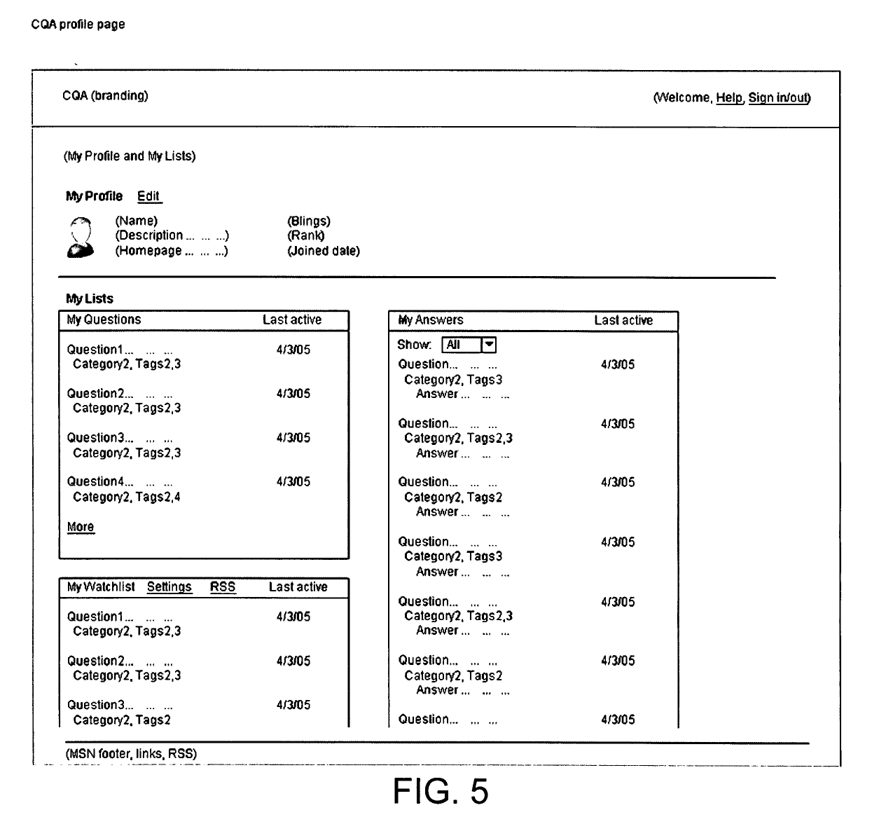

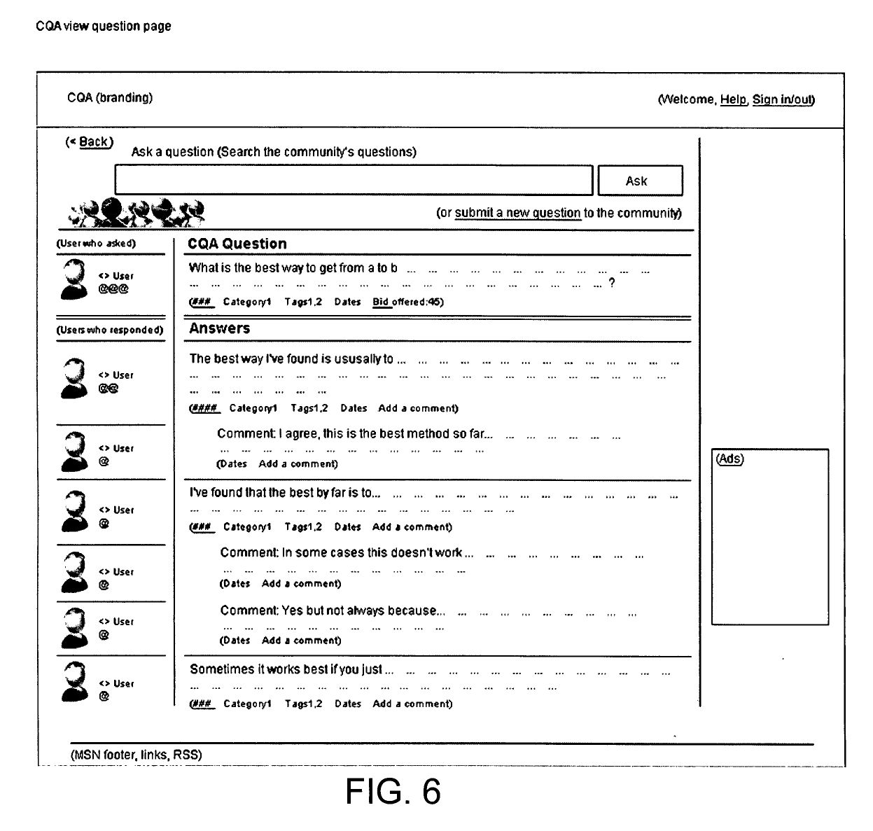

In general, the system of FIG. 1 is implemented by the user 106 accessing a home page (see FIGS. 3-5) asking questions (see FIG. 6) so that the system may return results based on the questions posed by the user 106. In one embodiment, questions may be viewed as having a life cycle which can be separated into various stages. For example, when a question first appears in the system as a search query, it may be labeled as a search question. Once a question has been posted by the CQA database for viewing by potential answerers 114, the question may be labeled as an unanswered question. Preferably, an unanswered question would be given a category, a description and a value such as a point bet. An unanswered question may have answers but no answers have been selected yet by the questioner 106 or no answers have been rated by others or by the database 102. When a question has answers which are in the process of being voted upon by the site users (e.g., a community) the question may be labeled as a community vote question. This would include questions with answers, none of which have been selected by the community or otherwise. Once the community selects an answer or the questioner selects an answer the question may be labeled in its life cycle as an answered question. Questions may also fall into the category of an unresolved question. This would include a question whose time has expired and never receives an answer. Such questions generally would not show up in search results when answerers are searching for questions to answer.

According to one embodiment, question and answer searching may be implemented as follows. When a questioner 106 asks a question, common words are removed from the question and then other questions, answers and category names are searched based on the remaining words (e.g., the key words). The key words may also be used to match related ads to the questions and to display the ads to the questioner or to others who have interest in the question. Questions and answers may be categorized into various categories as users become proficient and develop a reputation or a rating in a particular category the users may be identified as experts in a particular category. A user may be identified as an expert in a category either based on the questions that they have answered or based on their own submissions. Users are also returned as results When a query is submitted to the system that matches a category to which a user is a recognized expert, the name of the expert can be returned as a result. The user asking the question can then choose to send the question directly to the expert as an alert or email or some other appropriate short-time communication mechanism. It is assumed that the expert user has agreed to be queried. Based on what questions are returned in the initial search, the system may suggest categories for the particular question being searched.

In one embodiment, the user may designate the community or field in which a question will be presented. For example, if a questioner 106 posts a question directly as indicated at 104, the question may be submitted to the entire site or to a community, e.g., it may be restricted to a particular social network that has been identified previously by the questioner 106. The questioner may offer points (e.g., a point bet) to entice others to answer the question and/or the user may restrict how long the question stays open.

In one embodiment, a static taxonomy may be implemented to categorize questions. The static taxonomy would create a hierarchical structure and each question would belong to one category. Users would not be able to add categories to a particular question. For example, a single category would be defined as technology/software/search. In another embodiment, a dynamic taxonomy may be employed. With dynamic taxonomy all of the categories are user created so that a question can belong to multiple categories. For example, categories for a single question would be defined as technology and search and software. Users/answerers 114 are able to view all the questions in a single category. They can remove or add questions based on the question's place in the question lifecycle.

As noted above, users may be grouped and ranked in various ways. For example, users may be able to define a network of people such as a community that they want to be able to ask questions to without posting questions to the entire world. Users may be presented to other users in order based on ranked based on the number of points that a user has. In general, all users are shown each others' network, ranks and points.

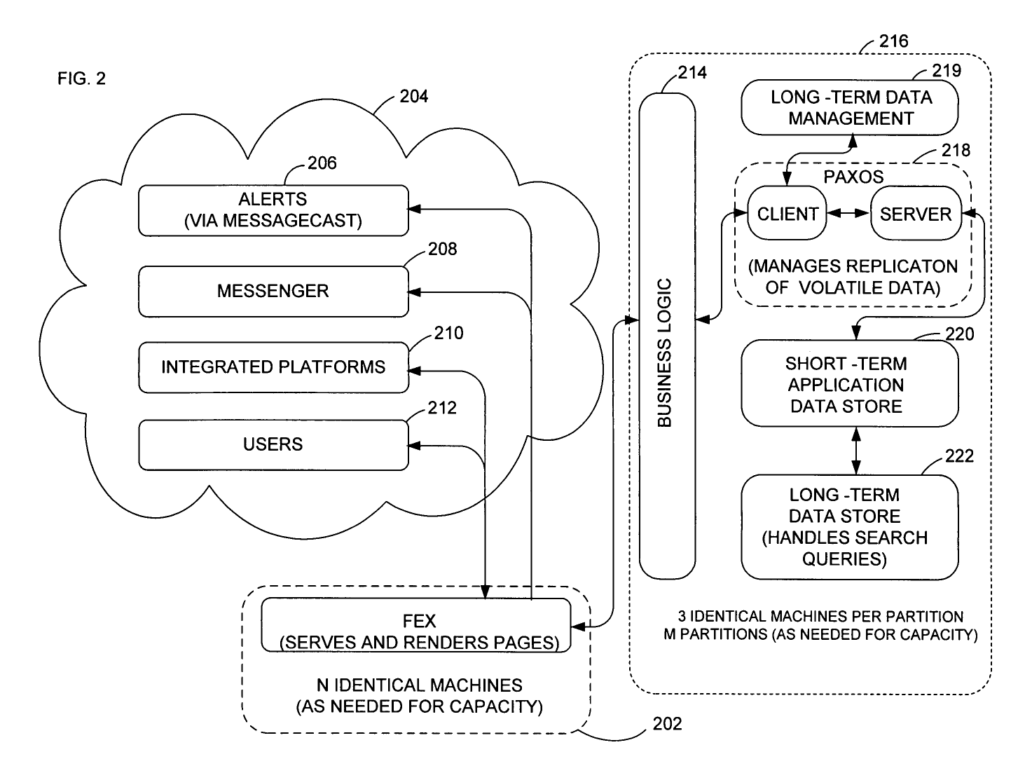

FIG. 2 is a block diagram of one embodiment of the architecture of a system according to the invention. A front end server 202 which serves and renders pages communicates with various sources and resources via an internet 204. For example, the communications may involve alerts 206 via a message cast (syndication), communications via messaging systems 208, communications via an integrated platform 210 such as a PASSPORT™ System or communications directly with users 212. The front end servers 202 would be a plurality of identical machines, the number (N) of which would be dependent upon the capacity of the system. The front end servers 202 would interface with a business logic 214 which implements the economy of the system. The business logic 214 is part of a CQA back end 216. The CQA back end 216 handles read and update requests from the front end server 202. As noted above, there would be multiple front ends depending on capacity. It is also contemplated that there may be multiple (M) back ends 216. Thus the number of machines would be dependent on load handling and failover. In one embodiment, there would be some form of stickiness between front ends and back ends to help with caching behavior (either session level stickiness or question identification and user identification stickiness). By stickiness, it is meant that the caching behavior would remain on for a minimum period of time. Cache stickiness refers to the affinity a front end machine has for a back end machine. In other words, if a front end machine receives a request, it will typically send that request to the same back end machine depending on some property of the query. For instance, a hash value could be calculated for the query and all queries with the same hash value would be sent to the same machine. Another form of stickiness is user affinity. A single back end machine or sub-set of backend machines might handle all users whose user IDs fall within a given range. As machines go out of service, the affinities need to change. In one embodiment, the stickiness may be limited in time.

For at least the first period of time such as a year or two after a system according to the invention is implemented, it is contemplated the full CQA data set within the database 102 may be smaller than the disk capacity such as the capacity of a Monarch server. As a particular example, if the data set reaches 10 million documents (wherein a document is a question and all its answers) and the average document is 100 K bytes, this would result in a data set of 1 terabyte uncompressed. Ten million documents should present a sufficiently successful collection of questions and answers to provide depth of information and reliable answers. Thus, for the near term, when the system is initially set up, it can be assumed that the CQA back end 216 has a full copy of the data set and that multiple servers are used to handle redundancy and high read traffic. In a case where there is a high amount of traffic update or the data set grows quickly, the data set and servers may be partitioned. For example, application level partitioning may be employed which means that multiple instances of lower level replication and repository services may be created without a significant concern for cross-traffic between instances (e.g., for synchronizing updates).

The CQA business logic 214 accepts read and write requests from the front end server 202. All requests are treated as atomic, e.g., multiple requests are not grouped as a single transaction. In other words, each request is handled independent of any other request. The business logic 214 takes one or more read and/or write requests through a client/server layer 218 such as a Paxos layer for each incoming request. Each request to the Paxos layer 218 is treated as atomic (again, no support for grouping multiple requests as a single transaction). Long-term data is data that has not been accessed for a predetermined number of hours. Long-term data is data in which no user is actively working on and its purpose is primarily for searching only. The back end performs long-term data management 220 which is above the Paxos layers 218 so that the Paxos server can be used to reliably coordinate and maintain states of the long-term data across all servers (e.g., migrating data from short-term to long-term storage). Short-term data is data that is actively being viewed by users within the predetermined period.

Usually, short-term data is data that has involved questions and answers that have been recently asked and/or answered. A short-term data application storer 220 and related state information is below the Paxos server 218 since synchronization and replication is managed by the Paxos layer 218. As shown in FIG. 2, the long-term data storer (for handling search queries) 222 is located below the Paxos layer. However, the long-term data layer does not have to be below the Paxos server 218. In one embodiment it is located below because it is convenient to facilitate combining short-term and long-term data when processing requests (e.g., for a join-like operation it is better to do the join in a single layer and just ship the results up through the layers rather than shipping partial join layer data through the layers). Also, keeping all data on the same side of the state management layers avoids some potential synchronization complications.

The business logic 214 is preferably request driven whereas the long-term data management layer 219 is primarily self-driven, relying on timers to drive periodic polling of the system state and possibly receiving alerts which might be sent by the lower layers below the Paxos layer 218.

In one embodiment, it is contemplated that the Paxos server 218 would serialize all requests, in which case such requests would preferably be executed quickly. For a complex operation like merging some short-term data 220 with some long-term data 222 multiple Paxos requests may be employed in order to drive a state machine below the Paxos layers 218. As a particular example, the long-term data management 219 may issue a smart merge request which also sets a merge in progress state flag to prevent other back ends from starting a merge. Thus, the duration of the Paxos request is very short even though the actual work may take a long time (many seconds or even minutes). The Paxos server 218 will need to check on the work progress and when complete issue another request that changes the state (e.g., done or start copying chunk files). One cost of this approach is that if a back end crashes, the state machine needs to be cleaned up by the survivors.

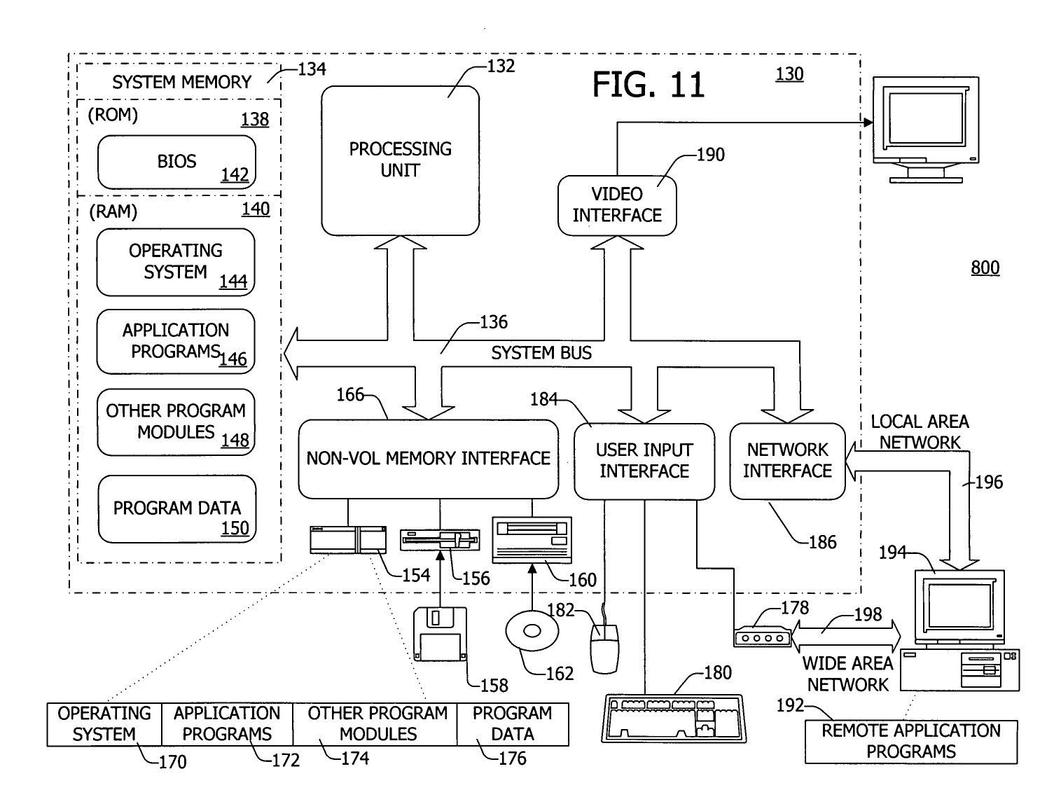

FIG. 11 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that may be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 11 illustrates operating system 144, application programs 146, other program modules 148, and program data 150.

The computer 130 may also include other removable/non-removable, volatile/nonvolatile computer storage media. For example, FIG. 11 illustrates a hard disk drive 154 that reads from or writes to non-removable, nonvolatile magnetic media. FIG. 11 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 11, provide storage of computer readable instructions, data structures, program modules and other data for the computer 130. In FIG. 11, for example, hard disk drive 154 is illustrated as storing operating system 170, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 11 include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 11 illustrates remote application programs 192 as residing on the memory device. The network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

In operation, computer 130 executes computer-executable instructions such as those implementing the communication illustrated in FIG. 1 to populate database 102 and blogs 110 and 120.

The order of execution or performance of the methods illustrated and described herein is not essential, unless otherwise specified. That is, elements of the methods may be performed in any order, unless otherwise specified, and that the methods may include more or less elements than those disclosed herein. For example, it is contemplated that executing or performing a particular element before, contemporaneously with, or after another element is within the scope of the invention.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

### Appendix 1: Gaming the Point System

How can users game the system and how do we prevent this?

If a user can create as many accounts as they want and ask questions, then that user can game the system and devalue the currency. Others inhibit this by locking the ID to your SSN! Your account is unique to you and you are not able to create new accounts.

There are several ways that users could game this system. The most destructive would be ones that devalued the currency of the system (the points and best answers):

create a cluster of IDs that answer each other's questions (to gain points & best answers)

create a cluster of IDs and use the majority to raise the value of one ID (to gain points & best answers)

Strategies for inhibit this:

1. all questions get put up for a community vote and that is what determines your score (this could still be gamed, it just might diffuse the affect)

a. Pro—the user would have to ask the question and then immediately use 10, 20 fakes—this makes it more difficult and time consuming

b. Pro—other users might influence the vote and the chance

c. Con—frustrates normal users by involving extra step

d. Con—at best slows down the cheating

e. Con—can still be cheated programmatically

2. we use paid points for submitting questions so that there is a cost associated with a new user

a. Pro—there is a cost to starting a user and that cost, even if small, would be prohibitive to starting a number of users

b. Con—users have to pay to use the system

3. use automation to detect this problem; scan the logs and detect when user's are clustered together; automatically remove that user's offending points

a. Pro—no burden is placed on user

b. Con—automation can be wrong; we would have to have a way for users to get their points back

4. create temporary power-users to approve best answers and to report fake users

a. Pro—temporary so that the editors can't abuse their power forever

b. Con—requires an active community

5. on any person's profile page have a list of who has answered their question & have a “report this fake user”

a. Pro—least burdensome on normal users

b. Con—only likely to catch big-time offenders

c. Con—automation can be wrong we would have to have a way for users to get their points back

6. we use CAPTCHA's at the time of a question submission

a. Pro—prevents users from automating the question & answer process

b. Con—burdensome to users

c. Con—at best slows down the cheating

Another method for gaming the system may be by creating questions and then deleting questions (to gain points). One solution to this is limit the benefit of creating questions.

What is claimed is:

1. A system for collecting question and answer pairs comprising:
A database of questions and answers to the questions, each question having a plurality of answers;
A question interface for providing the questions to the database from various sources;
An answer interface for providing the answers to the database from various sources;
A rating system for assigning an accuracy rating to each of the plurality of answers for each question.

2. The system of claim 1 wherein the question interface comprises at least one of the following:
A questioner interface allowing a questioner to post a question to the database;
A blog interface allowing a questioner to post a question to the database on a blog communicating with the database;
A messaging interface allowing a questioner to post a question to the database via a messaging system configured to communicate with the database;
An email interface allowing a questioner to post a question to the database via an email system configured to communicate with the database;

3. The system of claim 1 wherein the answer interface comprises at least one of the following:
a search engine for providing answers to the database by accessing at least one of the following: messaging systems, email systems, websites and blogs;
an answerer interface allowing a answerer to post a answer to the database.

4. The system of claim 1 wherein the database includes an syndication interface for syndicating answers to at least one of the following:
A questioner;
A questioner's blog;
An answerer;
Another blog;
Another user.

5. The system of claim 1 further comprising a blog interface wherein when a question or answer is posted to a blog, the blog interface posts the question or answer to the database or wherein when a question or answer is posted to the database, the blog interface posts the question or answer to the blog.

6. The system of claim 1 including a front end and a back end, the front end for receiving questions and answers and providing the received questions and answers to the back end and for rendering information in the database for presentation to a user in response to a request by the user.

7. The system of claim 6 wherein the back end implements business logic for the rating system, manages the storage and replication of questions and answers in the database and searches the database for questions and answer pairs in response to requests.

8. The system of claim 1 wherein the rating system rates answers to questions and/or rates answerers.

9. A system for collecting question and answer pairs comprising:
A database of questions and answers to the questions, each question having a plurality of answers;
A question interface for providing the questions to the database from various communications systems;
An answer interface for providing the answers to the database from various communications systems;
A rating system for assigning an accuracy rating to each of the plurality of answers for each question.

10. The system of claim 9 wherein the question interface comprises at least one of the following:
A questioner interface allowing a questioner to post a question to the database via a user interface communicating directly with the system;
A blog interface allowing a questioner to post a question to the database on a blog communicating with the database;
A messaging interface allowing a questioner to post a question to the database via a messaging system configured to communicate with the database;
An email interface allowing a questioner to post a question to the database via an email system configured to communicate with the database.

11. The system of claim 9 wherein the answer interface comprises at least one of the following:
a search engine for providing answers to the database by communicating with at least one of the following: messaging systems, email systems, websites and blogs;
an answerer interface allowing a answerer to post a answer to the database.

12. The system of claim 9 wherein the database includes an syndication interface for syndicating answers by communicating directly with at least one of the following:
A questioner via a user interface;
A questioner's blog;
An answerer via a user interface;
Another blog;
Another user via a user interface.

13. The system of claim 9 further comprising a blog interface wherein when a question or answer is posted to a blog, the blog interface posts the question or answer to the database or wherein when a question or answer is posted to the database, the blog interface posts the question or answer to the blog.

14. The system of claim 9 including a front end and a back end, the front end for receiving questions and answers and providing the received questions and answers to the back end and for rendering information in the database for presentation to a user in response to a request by the user.

15. The system of claim 14 wherein the back end implements business logic for the rating system, manages the storage and replication of questions and answers in the database and searches the database for questions and answer pairs in response to requests.

16. A method for collecting question and answer pairs comprising:
collecting questions and answers to the questions in a database, each question having a plurality of answers;
providing the questions to the database from various sources;
providing the answers to the database from various sources;
assigning an accuracy rating to each of the plurality of answers for each question.

17. The method of claim 16 wherein providing the questions interface comprises at least one of the following:
allowing a questioner to post a question to the database;
allowing a questioner to post a question to the database on a blog communicating with the database;
allowing a questioner to post a question to the database via a messaging system configured to communicate with the database;
allowing a questioner to post a question to the database via an email system configured to communicate with the database;

18. The method of claim 16 further comprising providing answers to the database by accessing at least one of the following: messaging systems, email systems, websites and blogs.

19. The method of claim 16 further comprising syndicating answers to at least one of the following:
A questioner;
A questioner's blog;
An answer;
Another blog;
Another user.

20. The method of claim 16 further comprising rating answers to questions and/or rates answerers.
